(19) United States
(12) Patent Application Publication
(10) Pub. No.: US 2002/0080190 A1
(43) Pub. Date: Jun. 27, 2002

(54) Back-up and usage of secure copies of smart card data objects

(75) Inventors: Ernst-Michael Hamann, Boeblingen (DE); Klemens Klaffke, Boeblingen (DE); Robert Sulzmann, Holzgerlingen (DE)

Correspondence Address: A. Bruce Clay, IBM Corporation, Dept. T81/Bldg. 503, P.O. Box 12195, Research Triangle Park, NC, 27709, US

(73) Assignee: International Business Machines Corporation, Armonk, NY (US)

(21) Appl. No.: 10/016,907

(22) Filed: Dec. 14, 2001

(30) Foreign Application Priority Data
Dec. 23, 2000 (EP) 00128498.3

(51) Int. Cl. G09G 5/00; G06F 12/14; G06F 12/16

(52) U.S. Cl. 345/810; 711/115; 711/162; 711/163

(57) ABSTRACT

A virtual smart card (VSC) is a software implemented version of a real smart card providing the equivalent functionality of a real smart card. The VSC is created and used by a VSC control program which handles the creation, the security and the read/write process of the VSC. The VSC has a logical file structure comprising a public area, a private area, a secure key area, a password area, and a unique identifier area. Data objects in the public area have no access restrictions, data objects placed into the private area are encrypted and can be accessed with a password, and the data objects placed into the secret key area are encrypted and only accessible by a VSC control program. Each VSC may be addressed by a unique identifier (ID). All data objects can be stored and retrieved on/from the virtual smart card's public and private area via the virtual smart card control program using a communication component.

The present invention is related to a method and system for secure back-up and usage of secure copies of smart card data objects, especially in the case when the smart card is lost or damaged or data objects stored on the smart card are not accessible or destroyed.

### BACKGROUND OF THE INVENTION

Increasing numbers of organizations which issue transaction cards to their users, customers, or employees require cards tailored to meet the requirements of their particular service or application. These organizations also want the cards to contain data about the cardholder. Existing transaction cards encode such data in a magnetic stripe on the back of the card but the amount of data that can be held by a magnetic stripe is limited. A new type of transaction card (so called smart cards) embeds a microprocessor computer chip in the plastic of the card to greatly increase the card's data storage capacity. Additionally, sophisticated card applications specific to the card issuer can execute in certain varieties of the chips, and the chip may also contain a type of operating system. Transaction cards with embedded chips are referred to in the industry as portable programmed data carriers, more commonly called “smart cards” (the term “smart card” used in the present invention also covers any programmed data carrier used in any portable device, like mobile phone, digital personal assistant etc., to securely hold subscriber specific information). The chip in a smart card is programmed with initialization and/or personalization data.

The initialization data comprises two major types of information: application data objects and security data objects. The application data object is common to all cards for a given card application and includes application program code and variables.

The security data objects prevents fraudulent use of the card and is usually provided in the form of “secure keys”.

Smart cards are also programmed with information specific to an individual cardholder through a process called “personalization”. The personalization information for a smart card is similar to the personalization information currently contained on non-smart cards, such as the cardholder's name, account number, card expiration date, and so on. Because of its increased storage capacity, the chip in a smart card can contain additional data beyond the basic information on the standard transaction card including a graphical representation of the individual's signature, data defining the types of service the cardholder is entitled to, and account limits for those services.

The majority of current smart cards have a file system integrated into the operating system. A file system on a smart card supports the storage and retrieval of all kind of data objects and is useful for many types of applications. Normally, a file system consists of directories (DF) and files (EF).

Data objects of different applications, security data objects and personalization data objects being stored in a smart card are difficult to backup. Each application has to handle an own backup of their data objects. In a case of lost or damaged smart card it is not always possible to re-initialize a new smart card with the same content of the lost or damaged smart card. Furthermore, smart card-dependent applications may not be used until a new smart card has been issued. The issue of a new smart card having the same content as the original one is very difficult, time consuming, and therefore expensive because the overall initialization and personalization process has to be repeated without having the guarantee to get a new smart card with the same content as the original one.

It is therefore object of the present invention to provide an improved system and method allowing easy and secure back-up of the content of a smart card.

It is further object of the present invention to provide an improved system and method allowing easy and secure updates on smart cards already issued.

It is further object of the present invention to provide an improved system and method allowing secure copies of smart card data objects.

It is further object of the present invention to provide a system and method for allowing usage of smart card-dependent applications when the smart card is lost or damaged.

Finally, it is object of the present invention to provide a system and method for issuing a new smart card having the same content as the original one when the original smart card is lost, damaged, or not accessible.

These objects are solved by the features of the independent claims. Further preferred embodiments of the present invention are laid down in the dependent claims.

The present invention discloses a system and method for back-up and usage of secure copies of smart card data objects, providing a virtual smart card (VSC) having the same defined logical file structure and the same content of data objects as its assigned real smart card, a virtual smart control program handling the creation as well the read/write process of the VSC, a communication component allowing communication between the virtual smart card and its assigned real smart card, and preferably a smart card manager graphical user interface component allowing different actions with respect to data objects to be securely copied on the virtual or real smart card via the communication component.

The VSC is a software implemented version of a real smart card providing the equivalent functionality of a real smart card. The VSC is created and used by a VSC control program handling the creation, the security and the read/write process of the VSC.

VSC having a logical file structure comprising a public area, a private area, a secure key area, password area, and an unique identifier area. The data objects contained in the public area having no access restrictions, data objects placed into the private area are encrypted an d c an be accessed by using a password, and the data objects plac ed into secret key area are encrypted and only accessible by the VSC control program. Each VSC may be addressed by unique identifier (ID).

All data objects can be stored and retrieved on/from the virtual smart card's public and private area via the virtual smart card control program using the communication component.

The smart card manager graphical user interface component allows different tasks to create and to use VSCs and handles different tasks required for real smart cards and VSCs to handle data objects, e.g. importing/exporting, copying/pasting data objects.

An essential advantage of this invention is that backed-up smart card data objects in the VSC allows the user to continue working with the most of the applications if the real smart card lost or damaged

### BRIEF DESCRIPTION OF THE DRAWINGS

In the following a preferred implementation of the present invention is described with reference to the drawings in which

FIG. 1 shows the basic file structure of the virtual smart card (VSC) used by the present invention for back-up and usage of secure copies of smart card objects

FIG. 2 shows the preferred inventive architecture of the present invention

FIGS. 3A-Y shows the inventive method for back-up and usage of secure copies of smart card objects by means of screen prints provided by the smart card manager GUI

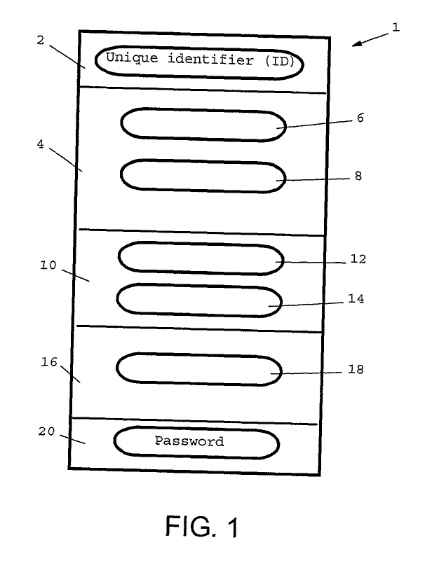

In FIG. 1 it is shown a logical file structure of a virtual smart card (VSC-1) used by the present invention. The VSC (1) is preferably created by the back-up system having access to the real smart card and the virtual smart card control program handling creation of the virtual smart card.

The logical file structure of the VSC (1) is preferably defined by the following data areas:

a public area (4) in which public data objects having no access conditions are placed, e.g. Certificate (6) and address (8)

a private area (10) in which private objects being encrypted are placed; private objects may only be accessed providing a password (10), e.g. account no (12) and key information (14)

a secret key area (16) in which key objects being encrypted are placed; key objects are not accessible however they can be used by the VSC control program, e.g. private key for signing (18)

a password area (20) in which a password being encrypted is placed

an unique identifier area (2) in which an unique identifier for identifying a VSC is placed

The VSC file (1) may be built preferably as a dedicated file with variable length. Within that variable record file, the length of each data area (2, 4, 10, 16, 20) can be varying. The unique identifier (2) is preferably contained as part of the file header information. Further header information may be:

type of file

structure of the file

length of the file

access conditions

attribute

file hierarchy

The VSC may be accessed by the unique identifier (2) only.

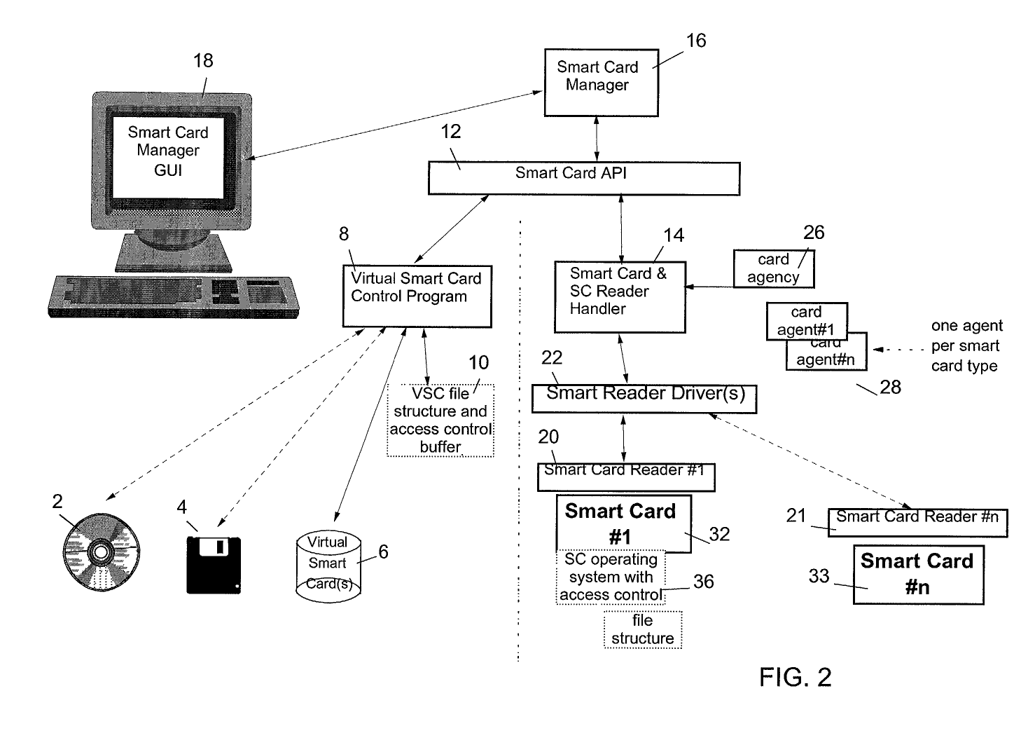

FIG. 2 shows the preferred inventive architecture of the present invention.

The VSC is created by the virtual smart card control program (18) as described to FIG. 1 and may be stored as file on any permanent storage media like a CD-ROM (2), a floppy (4) or a hard disk (6). VSCs may be accessed via the virtual smart card control program (8) providing the required read/write functionality. The virtual smart card control program (8) being preferably installed at the back-up system performs a consistency check on the format and the data encryption before accepting the content of the VSC to be accessed. Each VSC to be accessed is preferably copied from a permanent storage media into the internal “VSC file structure and access control buffer” (10) where it is accessible by the smart card API (12) (application programming interface). The logic for protecting the private data areas of the VSC (by password) and the cryptographic routines used, e.g. for data encryption and authentication, are implemented inside the virtual smart card control program (8) instead using the “smart card operating system with access control” stored in the ROM of the real smart card.

The “smart card API (12)” provides both interfaces to the virtual smart cards via the “smart card control program(8)” and the real smart card and the real smart card reader(s) via the “smart card & SC reader handler (14)”.

The smart card manager (16) allows the user to administrate the content of his real smart card and virtual smart card via an easy to use graphical user interface of the smart card manager (18-GUI). The user can, for example, add his favorite URLs to the smart card, as well as frequently used personal information, The user is able to launch his default Internet browser with the URL from the GUI and may add his business card to his standard address book. For emergency backup a function is provided to copy all objects except private keys to a assigned VSC or another real smart card or to save them as file.

The smart card reader (20, 21) is the connector between the real smart card and the virtual smart card. Smart card readers come with different software support called smart reader driver (22). The smart card & SC reader handler (14) provides an interface to all available smart card reader driver(s) (22) as well as an interface to a card agency (26) providing an interface to all available card agents (28) providing smart card specific commands (APDUs). APDUs are used to exchange data objects between the data processing system having access to the virtual smart card and the real smart card.

ISO 7816-4 defines two types of APDUs: Command APDUs, which are sent to the smart cards and Response APDUs, which are sent from the smart card to reply to command.

Each real smart card (32, 33) has an operating system (36) with access control. Access to data objects in private areas are controlled by access conditions. Before a certain operation can be performed on a data object, the access conditions for the specified operation must be satisfied.

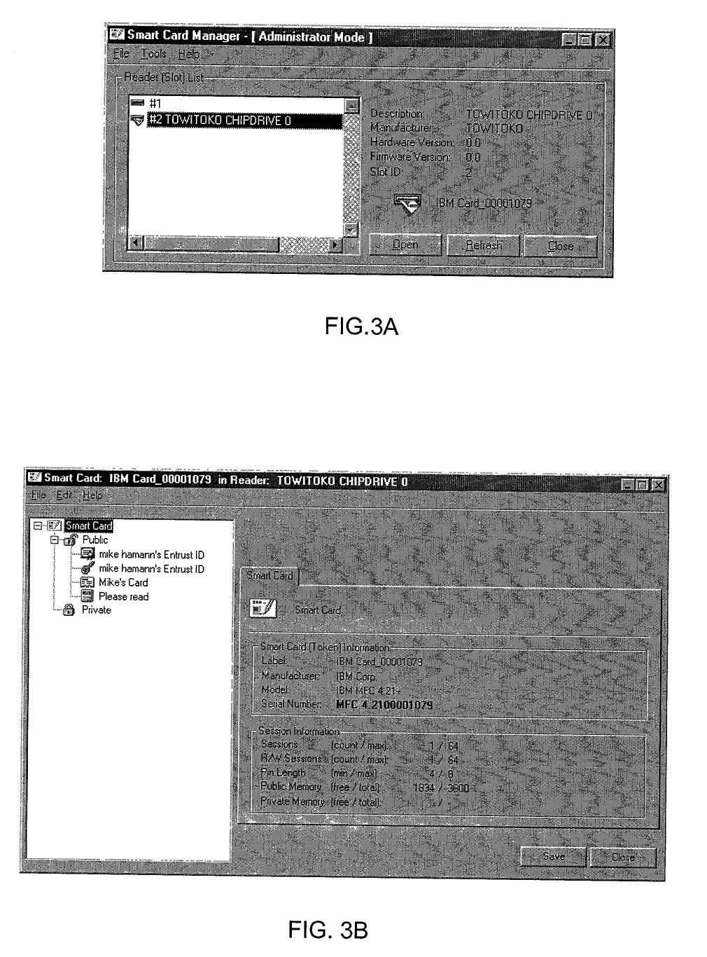

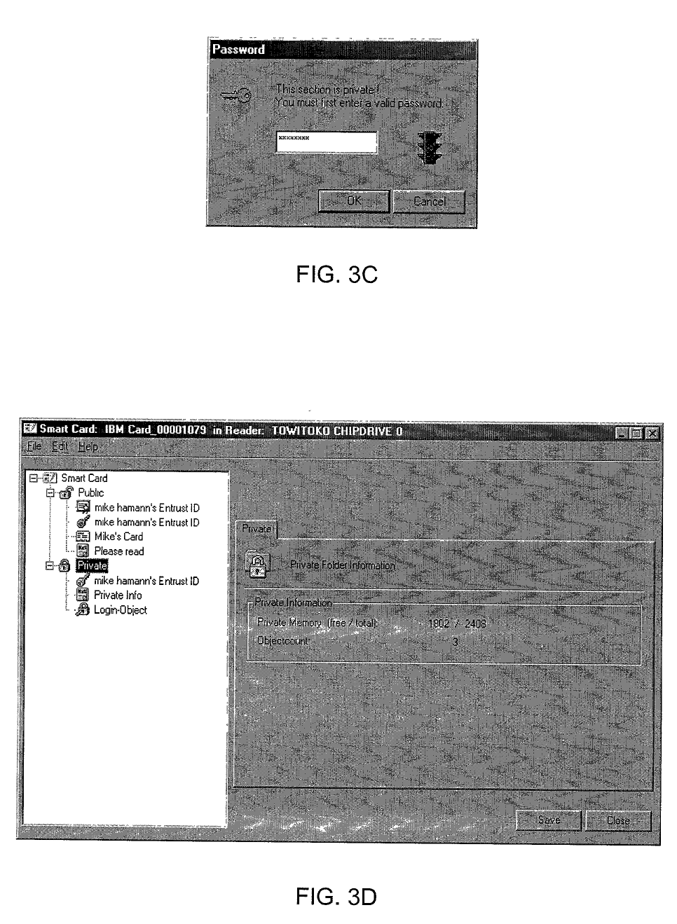

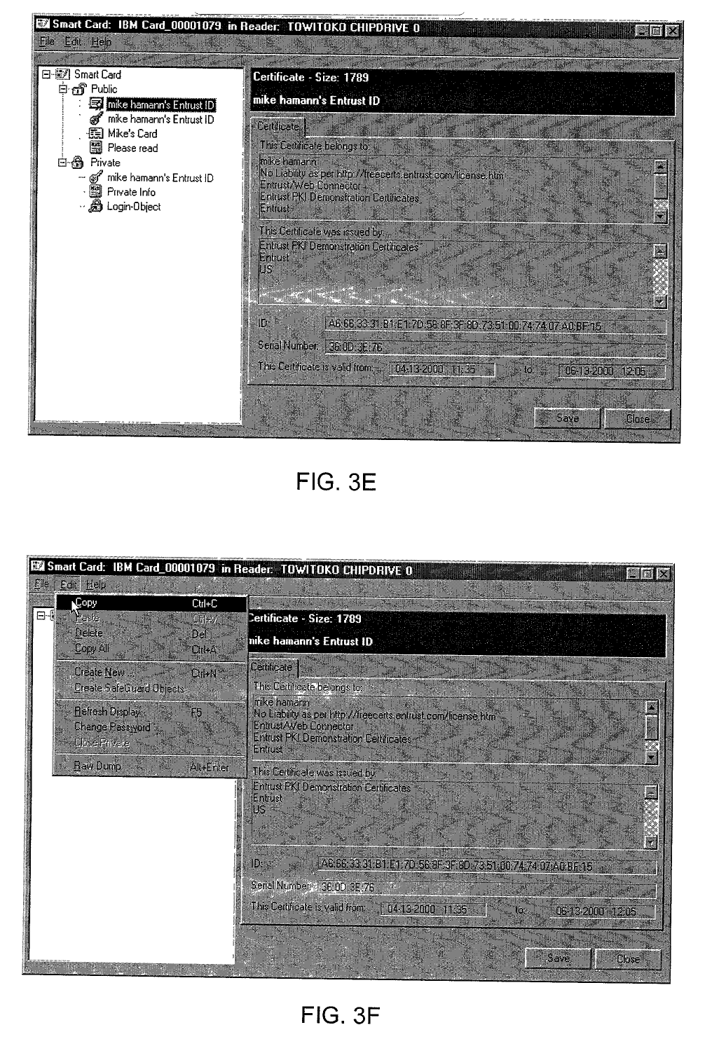

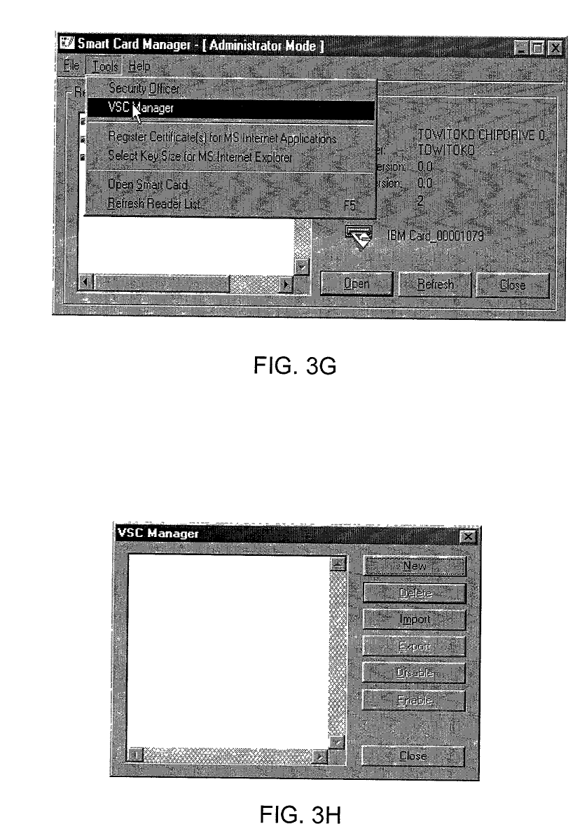

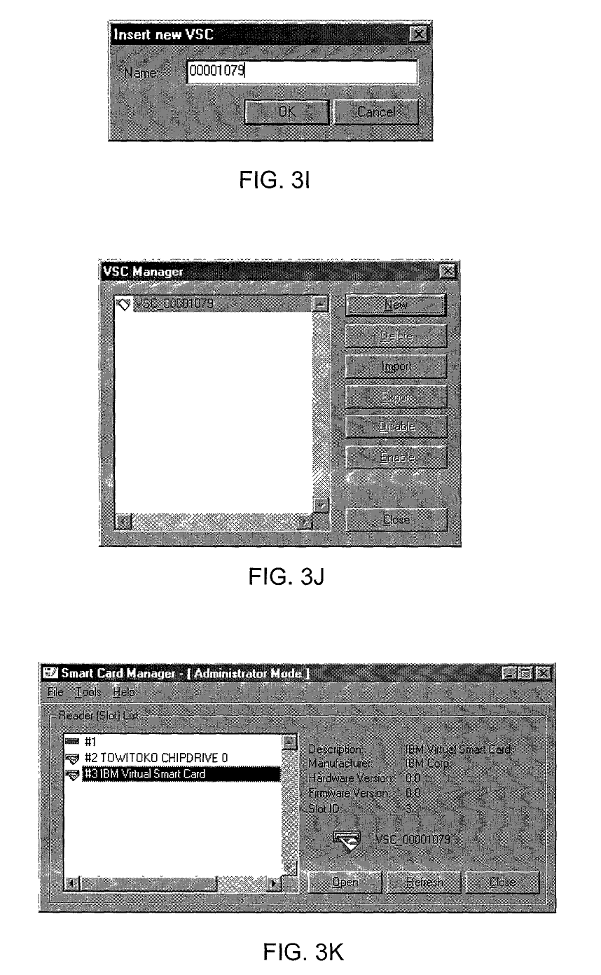

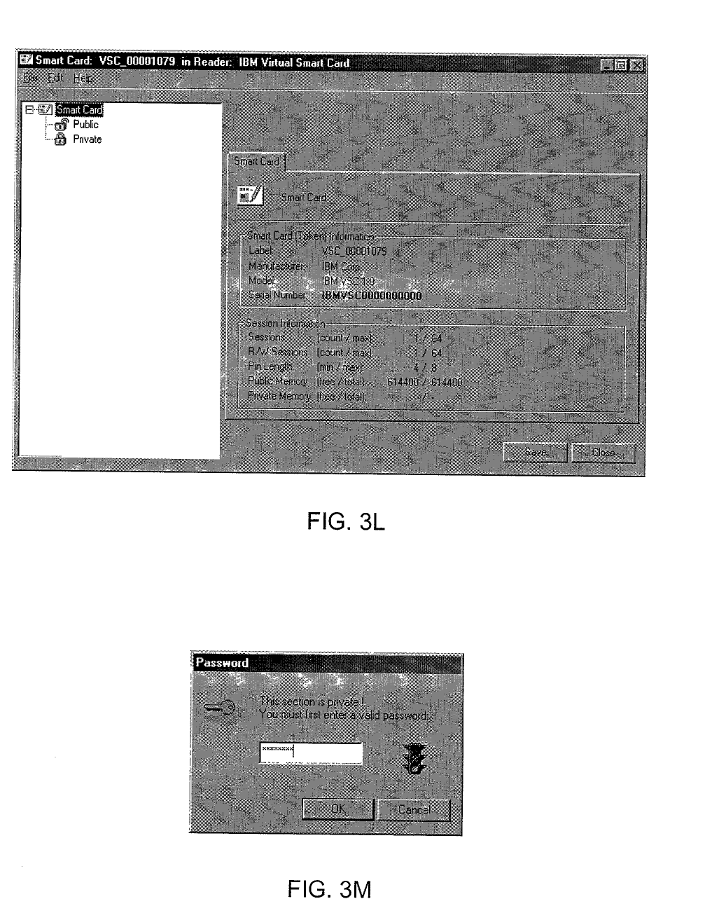

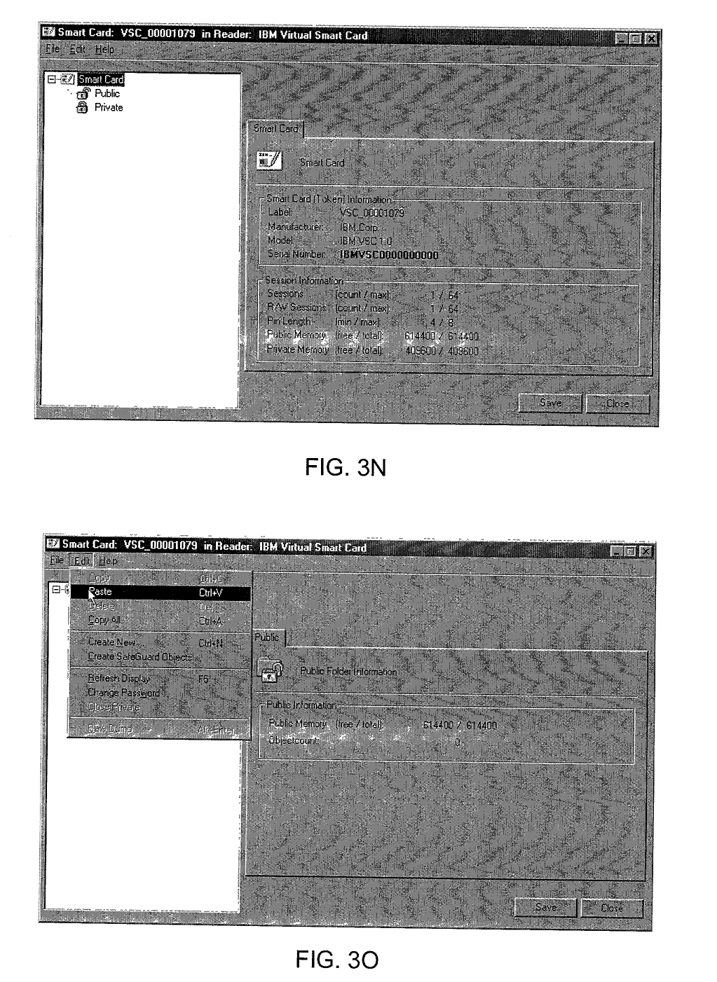

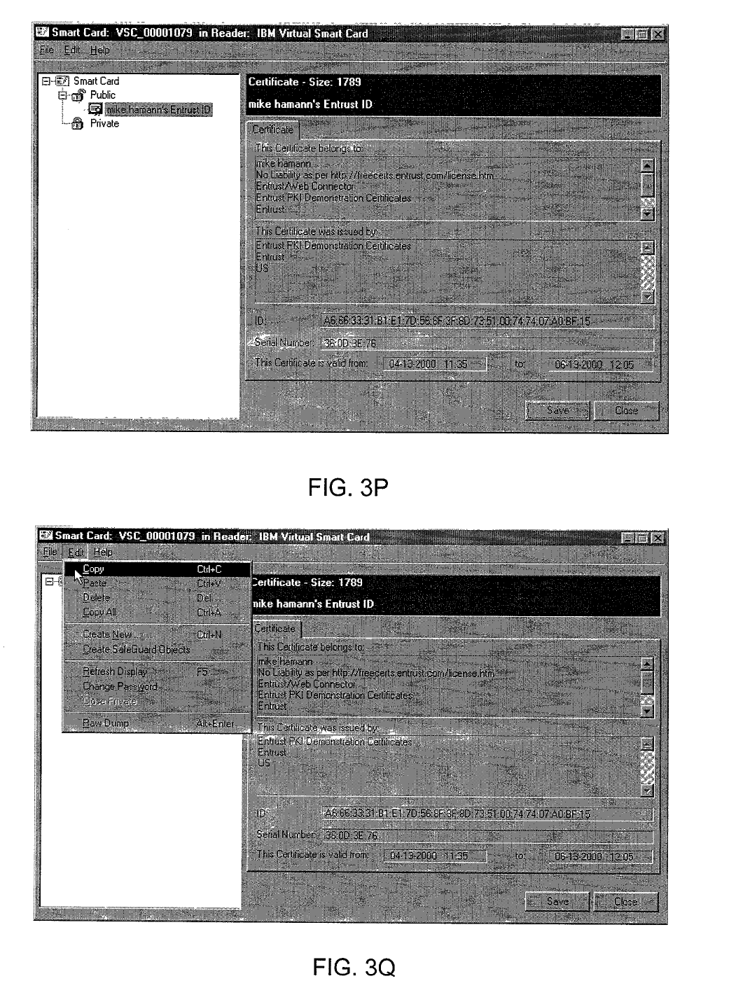

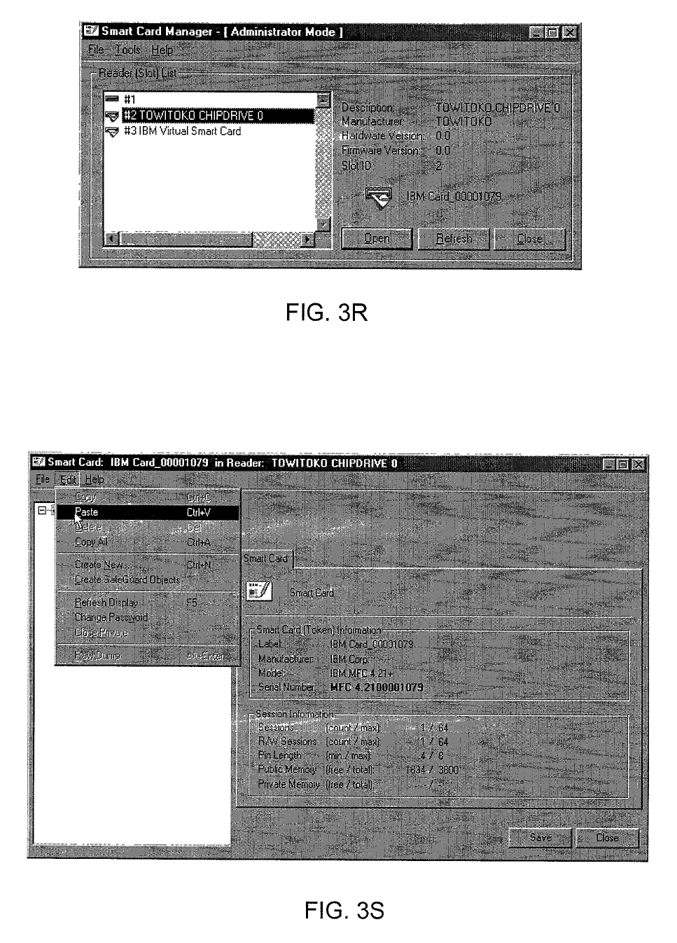

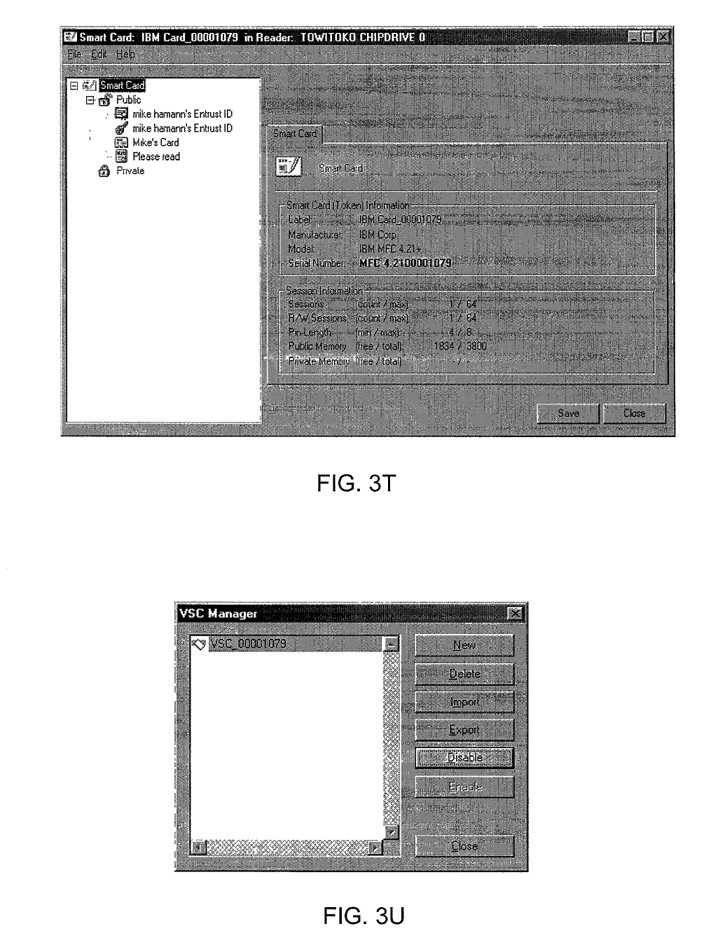

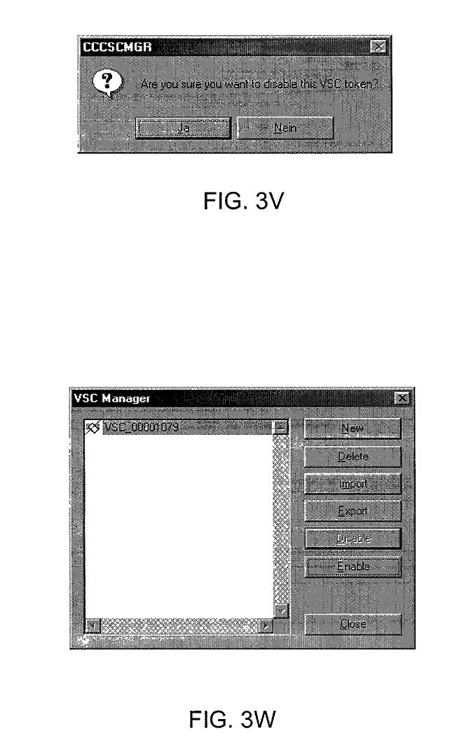

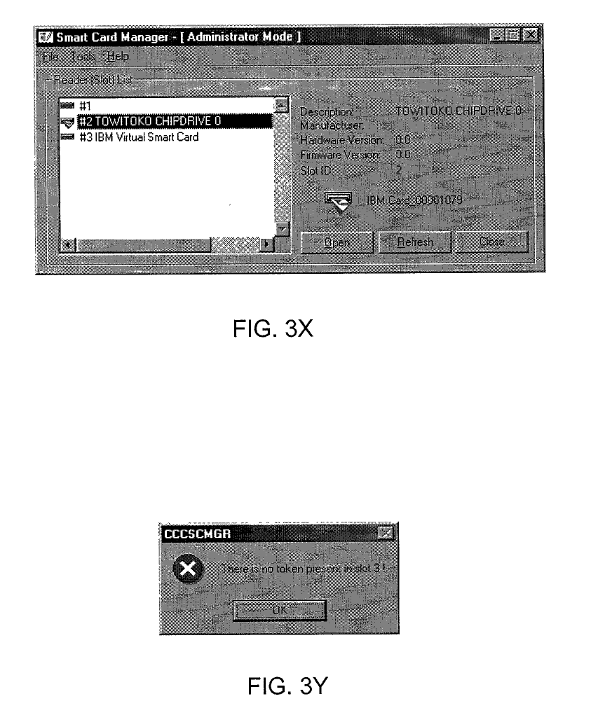

FIGS. 3 A-Y shows screen prints of the graphical user interface of the smart card manager for performing a back-up and usage of secure copies of smart card data objects by means of an architecture as shown in FIG. 2.

A card holder is owner of a smart card and wants to back-up the data objects stored in the smart card for the case the smart card is lost or the data objects stored in the smart card are not accessible or completely destroyed.

The smart card is inserted into a smart card reader and the smart card manager is started.

The GUI of the smart card manager displays all available smart card readers and VSCs. In FIG. 3A two smart card readers are displayed while the first # is not attached and the second has a TOITTKI CHIPDRIVE 0 attached with smart card label “IBM 00001079” inserted. The smart card reader may be selected via a mouse double click and then the details of the smart card are displayed together with all public objects stored on the smart card (see FIG. 3B). The data objects presented as a file list in this example are four objects (mike hamann's Entrust ID, mike hamann's Entrust ID, Mike's card, Please read). If the password protected private data object area should be opened the user has to select that area and the smart card manager asks for a valid smart card password (see FIG. 3C). After insertion of a valid smart card password the smart card manager displays all public and private data objects stored on the smart card (see FIG. 3D). The private area contains three data objects (mike hamann's Entrust ID, Private Info, Login-object). Now the user may select objects to be backed-up or copied by clicking at the objects (see FIG. 3E—mike hamann's Entrust ID). By selecting the “Copy command from the Edit menu of the smart card manager GUI” (see FIG. 3F) the smart card manager stores the selected objected in an intermediate buffer. Furthermore, the smart card manager GUI offers via the Edit menu the possibility to copy all objects stored in the smart card (see FIG. 3F). The real smart card may be left by pressing the “Close” button.

The virtual smart card control program may be started from the “Tools” menu as shown in FIG. 3G. The VSC manager opens a menu having a button for creating a new VSC (see FIG. 3H). A new VSC can be created by pressing the button “New” (see FIG. 3H). The identifier should be specified using the serial number of the real smart to be assigned to the new VSC (see FIG. 3I). Now a VSC with the label “VSC 00001079” is available (see FIG. 4K). More VSCs may be created or imported from an external storage media in this menu. The virtual smart card manger GUI is left by pressing the “Close” button (see FIG. 3J).

The VSC manager now displays the created VSC in the “Reader List” as “IBM Virtual Smart Card” and the smart label “VSC 00001079” (see FIG. 3K).

The user may now select the VSC via double mouse click and then the details of the VSC are displayed in the manner like a real smart card (see FIGS. 3A-F). The serial number is always “IBMVSC00000000000” to indicate the software nature of this VSC to the using application. The VSCs are addressed via the file label only. If the user wants to open the “private data object area” too the smart card manager asks for a valid VSC password (see FIG. 3M). Now all public and private data objects stored on the VSC are displayed (see FIG. 3N). The user can select the “Paste” command from the Edit menu (see FIG. 4O). The smart card manager copies now the copies the objects from the intermediate buffer into the selected public or private of the VSC (see FIG. 3P shows the copied object “mike hamann's Entrust ID” as part of the public area). The “Save” button has to be pressed to save the object on the external storage media. This object may be used by other applications as before on the 11 real smart card. The file containing the VSC may be copied to another external storage media (e.g. diskette) as a back-up for later use.

In a case of lost of an data object on the real smart card either the VSC can be used directly as temporary “smart card” of the previously saved objects or may be transferred back to the real smart card using the same steps as described before in the opposite direction, i.e. copy the data objects from the VSC and paste them to the real smart card. These steps are shown in FIG. 3Q (copy data object from VSC), FIG. 3R (open the real smart card), FIG. 3S (paste data objects to real smart card) and FIG. 3T (data object is stored on a real smart card).

A virtual smart card may be saved also as “disabled VSC” in the normal VSC storage on disk and activated only in the case of an emergency as a back-up of the real smart card, e.g. when the smart card is lost.

These steps are shown in FIG. 3U: Select VSC and press the ‘Disable’ button and acknowledge this by press ‘Yes’ in the following menu—FIG. 3V. The disabled VSCs are then displayed in a different way compared to the active VSCs. In FIG. 3W a disabled VSC is displayed with a invalidated smart card icon and in FIG. 3X the virtual smart card reader is shown without an inserted smart card (FIG. 34).

A card holder owns a real smart card and wants to transfer objects to an intermediate storage in order to transfer these objects to another real smart card. An example is the transfer his own personal address book object to the real smart card of a business partner.

The process is similar to the one described above using the VSC as a back-up. The steps described in FIGS. 3A-K are identical. The steps described in FIGS. 3L-O are not required because another real smart card is available. Instead of selecting the VSC as described in FIG. 3P either a different smart card reader with the smart card of the business partner is selected or the same smart card reader is used for both cards by replacing the own card by the one of the business partner. All steps up to step FIG. 3U are performed using the real smart card of the business partner instead of the VSC.

At the end the same smart card object (e.g. the object ‘Mike's Card’) is also available on the (real) smart card of the business partner.

A card issuer wants to generate public key pair for the encryption of data for smart cards. In order to have a back-up of the private key he generates the key pair on a VSC which he created as described in case 1 FIGS. 3L-O. From this he copies the key(s) and all other data (e.g. the certificate for the key) to the (real) smart card. The generation of key pairs for a VSC and the transfer of the private keys into a real smart card are sensitive operations which should only be performed by a security administrator using a secure workstation with smart card reader attached. The VSC containing all objects is then transferred to a secure storage media (e.g. a read-only CD-ROM) and locked away at a safe place. In case of a loss of a smart card either the VSC can be used directly for decrypting the encrypted data or a new smart card may be generated for the card holder by transferring the objects previously stored on the VSC.

1. System for back-up of data objects stored on a real smart card comprising:
a virtual smart card control component (8) for handling creating of a virtual smart card and for providing the security and the read/write process for the virtual smart card (VSC-2, 4, 6)
a smart card manager component (18) for providing a menu controlled graphical user interface allowing user actions for initiating creation of a VSC and back-up of data objects being stored in said real smart into said corresponding area of said virtual smart card,
a communication component (12, 14, 20, 22, 26, 28) for transferring said data objects to be backed-up from said real smart card (32) to said virtual smart card (2, 4, 6) by using functionality of said virtual smart card control component (8).

2. System for secure copy of data objects being stored in a virtual smart card (2, 4, 6) into a real smart card (32) comprising:
a storage media (2, 4, 6) for providing a virtual smart card having data objects to be securely copied into the assigned area of a real smart card (20)
a virtual smart card control component (8) for handling creating of a virtual smart card and for providing the security and the read/write process for the virtual smart card (VSC)
a communication component (12, 14, 20, 22, 26, 28) for providing access to a real smart card via access to a smart card driver (22) assigned to the smart card reader (20) and a card agent (28) for providing smart card specific commands for writing said data objects to be securely copied from said intermediate buffer (10) into said assigned area of said real smart card (32)
a smart card manager component (18) providing a menu controlled graphical user interface allowing to initiate user actions for creation of a VSC and secure copy of data objects being stored in said virtual smart card into said corresponding area of said real smart card.

3. System according to claim 1, wherein said communication component comprising:
a smart card API component (12) providing an interface to said smart card manger component (18), an interface to said virtual control component (8), and an interface to a smart card & SC Reader Handler component (14) providing an interface to all available smart card reader driver(s)(22), wherein said smart card & SC Reader Handler (22) has an interface to a smart card agency component (26) providing an interface to all available smart card agent(s) (28) providing smart card specific commands.

4. System according to claim 1, wherein said smart card API (12), said smart card manager component (18) and said virtual smart card control component (8) form an integral component.

5. Method for back-up of data objects being stored on a real smart using a system according to claim 1:
characterized by the steps of:
opening and displaying data objects of a real smart card to be backed-up via said smart card manager graphical user interface
selecting data objects to be backed-up via said smart
card manager graphical user interface
automatically creating a virtual smart card (VSC) by said smart card control component via said smart card manager graphical user interface, wherein said created virtual smart card having a defined logical file structure being identical with the logical file structure of said real smart card in use
opening a data object area of said created virtual smart card for placing said data objects to be backed-up via said smart card manager graphical user interface
copying data objects to be selected into said area of said created virtual smart card via said smart card manager graphical user interface
storing said virtual smart card on a secure permanent storage media.

6. Method according to claim 5, wherein said step for automatically creating of said virtual smart card comprises the following steps:
automatically creating a defined file structure having defined areas for placing data objects by a
virtual smart card control program
automatically assigning a password and an unique identifier to said defined file structure created and storing both in the respective area of said defined file structure by said virtual smart card control program
electronically storing said defined file structure including said data objects on a storage media (virtual smart card.

7. Method according to claim 6, wherein said defined file structure of said virtual smart card comprising:
a public area in which public data objects having no access conditions are placed
a private area in which private data objects being encrypted are placed
a secret key area in which key data objects being encrypted are placed
a password area in which a password being encrypted is placed
an unique identifier area in which an unique identifier for identifying the VSC is placed.

8. Method according to claim 7, wherein said defined file structure of said virtual smart card is a dedicated file structure containing elementary files for defining the areas in which said data objects are to be placed.

9. Method according to claim 7, wherein user actions via said menu controlled graphical user interface with respect to the private areas of said virtual smart card require the input of a password.

10. Method according to claim 5, wherein said opening, copying, and storing steps are accomplished using a respective functionality provided by the virtual smart card control program.

11. Method according to claim 5, wherein said virtual smart card is created on a server system and is provided to a client system via a secure channel.

12. A computer program product stored on a computer usable medium comprising computer readable program means for causing a computer to perform the method of anyone of the claims 5 to 11 when said program product is executed on said computer.
